(19) United States
(12) Patent Application Publication
(10) Pub. No.: US 2013/0181093 A1
(43) Pub. Date: Jul. 18, 2013

(54) ANTI-ICING SYSTEM, WING, AIRCRAFT, AND ANTI-ICING METHOD

(71) Applicant: Nobuo Inoue, Tokyo (JP)

(72) Inventor: Nobuo Inoue, Tokyo (JP)

(21) Appl. No.: 13/824,639

(22) PCT Filed: Dec. 26, 2011
(86) PCT No.: PCT/JP2011/080044

§ 371 Date: Mar. 18, 2013

(30) Foreign Application Priority Data
Jan. 20, 2011 (JP) 2011-010093

(51) Int. Cl. B64D 15/00

(52) U.S. Cl. CPC B64D 15/00
USPC 244/134 R

(57) ABSTRACT

Provided are an anti-icing system, wing, aircraft, and anti-icing method which prevent icing on the aircraft flying in an environment under icing conditions, using a simple configuration. An anti-icing system according to the present invention generates a pressure wave by aiming at supercooled airborne water droplets existing in a traveling direction of an aircraft (10) and thereby changes the water droplets into ice by means of the pressure wave. To impart an acceleration of, for example, 10 G to the water droplets, the pressure wave is set to produce 0.9 to 3.3 [Pa] at a predetermined location by taking attenuation into consideration.

### TECHNICAL FIELD

The present invention relates to an anti-icing system, wing, aircraft, and anti-icing method which prevent icing on the aircraft flying in an environment under icing conditions.

### BACKGROUND ART

During parking, an aircraft could encounter an event in which snow accumulated on an airframe melts once and then adheres to the airframe or an event in which rain changes to snow accompanied by temperature drops, causing ice to cling fast to the aircraft. Such events do not pose a significant problem on the part of the airframe because ground equipments rather than the airframe are provided with equipment adapted to melt the snow or ice by sprinkling ethylene glycol or isopropyl alcohol heated to about 80 [° C.] over the airframe.

On the other hand, during flight, measures are expected to be taken on the part of the airframe. Although the airframe gets wet when flying through clouds containing water droplets or through rain, the water droplets are blown off the airframe by air pressure produced by aircraft speed. Thus, even if heat is removed by evaporation, causing the temperature to fall below zero, there is no problem.

Icing poses a problem when the aircraft has to fly under the conditions of supercooled water in which minute water droplets making up clouds exist in a liquid state in spite of subzero temperatures. In that case, the minute water droplets move in such a direction as to avoid the airframe due to airflow, but depending on the speed of the aircraft and size of the minute water droplets, the minute water droplets hit the airframe by failing to avoid the airframe. The supercooled water solidifies into ice on impact, adheres to forward part of the airframe, especially to forward wing edges, and grows there. This could cause changes in wing shapes, reducing the lift of the aircraft, reducing steerability, and resulting in unstable flight.

To prevent icing of the wings, anti-icing/de-icing systems are attached to forward wing portions and engine air inlets, which are liable to icing. Anti-icing/de-icing systems include a system which uses heat from a heater or bleed air, a system which uses deformation in external shapes of the wings and air inlets via rubber boots or magnetic coils, and a system which uses exudation of anti-icing liquid. PTL 1 discloses a technique for preventing icing by heating forward surfaces of an aircraft using high-temperature air from engines.

### CITATION LIST

### Patent Literature

{PTL 1} Japanese Unexamined Patent Application, Publication No. Sho 61-160395

### SUMMARY OF INVENTION

### Technical Problem

Conventional anti-icing/de-icing systems, whose main wings and other components have large areas to be protected from icing, have problems of increased size, large energy requirements, and increased weight. Therefore, large aircraft can mainly be equipped on their airframes with an anti-icing/de-icing system while lightweight small aircraft and the like, which are not equipped with an anti-icing/de-icing system, cannot fly in an icing environment for safety reasons. Fighter planes, which have thin wings for the purpose of maintaining high maneuverability and pursue weight reductions, are not normally equipped with an icing prevention system except for part around the engines. Consequently, after flying in the sky, if the sky over a base, which is a planned landing site, is a severe icing environment, the fighter plane is forced to change the planned landing site.

The present invention has been made in view of the above circumstances and has an object to provide an anti-icing system, wing, aircraft, and anti-icing method which prevent icing on the aircraft flying in an environment under icing conditions, using a simple configuration.

### Solution to Problem

To solve the above problem, an anti-icing system, wing, aircraft, and anti-icing method according to the present invention adopt the following solutions.

That is, an anti-icing system according to a first aspect of the present invention generates a pressure wave by aiming at supercooled airborne water droplets existing in a traveling direction of an aircraft and thereby changes the water droplets into ice by means of the pressure wave.

According to the first aspect, when supercooled airborne water droplets exist in the traveling direction of the aircraft, by generating the pressure wave before wings of the aircraft touch the water droplets, the aircraft can change the water droplets into ice, thereby preventing icing on the wings of the aircraft. That is, supercooled water droplets, which are in an unstable state, turn into ice upon impact in order to gain stability. However, according to the present invention, ice does not adhere to the wings because the pressure wave can actively change water droplets into ice, thereby removing the water droplets from the air in the traveling direction before the water droplets collide with the wings, causing ice to adhere to the wings. The pressure wave here is, for example, a sound wave.

Also, an anti-icing system according to a second aspect of the present invention generates a pressure wave in a range of 0.9 to 3.3 [Pa] at a predetermined location forward of an airframe by aiming at supercooled airborne water droplets existing in a traveling direction of an aircraft.

According to the second aspect, when supercooled airborne water droplets 15 to 50 μm in size exist in the traveling direction of the aircraft, if a pressure field of 0.9 to 3.3 [Pa] is created by generating the pressure wave before wings of the aircraft touch the water droplets, an acceleration of 10 G can be imparted to the water droplets. By applying an acceleration to the water droplets in this way, it is possible to change the water droplets into ice, thereby preventing icing on the wings of the aircraft.

Furthermore, a wing according to a third aspect of the present invention is equipped with the anti-icing system described above.

According to the third aspect, when the aircraft is flying, since the anti-icing system installed on the wing generates a pressure wave by aiming at the supercooled airborne water droplets existing in the traveling direction of the aircraft, the water droplets can be changed into ice in advance, thereby preventing icing on the wings and the like.

Furthermore, an aircraft according to a fourth aspect of the present invention is equipped with the anti-icing system.

According to the fourth aspect, if the anti-icing system installed on the aircraft generates a pressure wave by aiming at supercooled airborne water droplets which are likely to collide with the wings of the aircraft, icing on the wings of the aircraft can be prevented. The aircraft may be any of aircraft having fixed wings and aircraft having rotor blades.

Also, an anti-icing method according to a fifth aspect of the present invention generates a pressure wave by aiming at supercooled airborne water droplets existing in a traveling direction of an aircraft and thereby changes the water droplets into ice by means of the pressure wave.

According to the fifth aspect, when supercooled airborne water droplets exist in the traveling direction of the aircraft, by generating the pressure wave before wings of the aircraft touch the water droplets, the aircraft can change the water droplets into ice, removing the water droplets from the air in the traveling direction, and thereby prevent icing on the wings of the aircraft.

In the fifth aspect, the pressure wave generation may be achieved by explosion of gunpowder.

According to the fifth aspect, if the pressure wave is generated in the traveling direction of the airplane by exploding gunpowder in advance, ice does not adhere to the wings of the aircraft because the pressure wave can actively change water droplets into ice, thereby removing the water droplets from the air in the traveling direction before the water droplets collide with the wings, causing ice to adhere to the wings.

### Advantageous Effects of Invention

The present invention can prevent icing on the aircraft flying in an environment under icing conditions, using a simple configuration.

### {BRIEF DESCRIPTION OF DRAWINGS}

FIG. 1 is a perspective view showing an aircraft equipped with sound wave generators according to the present invention.

FIG. 2 is a perspective view showing the sound wave generator according to the present invention.

FIG. 3 is a sectional view taken along line A-A in FIG. 2.

FIG. 4 is a perspective view showing the sound wave generator according to the present invention.

FIG. 5 shows a graph illustrating a relationship between water droplet content [gr/m³] and water droplet diameter [μm] in an icing area “continuous.”

FIG. 6 shows a graph illustrating a relationship between atmospheric temperature [° F.] and pressure altitude [1000 Ft] in an icing area “continuous.”

FIG. 7 shows a graph illustrating a relationship between water droplet content [gr/m³] and water droplet diameter [μm] in an icing area “intermittent.”

FIG. 8 shows a graph illustrating a relationship between atmospheric temperature [° F.] and pressure altitude [1000 Ft] in an icing area “intermittent.”

FIG. 9 is an explanatory diagram illustrating an aircraft in flight and supercooled water in a flight environment.

FIG. 10 is an explanatory diagram illustrating an aircraft in flight and ice in a flight environment.

### DESCRIPTION OF EMBODIMENTS

An anti-icing system and anti-icing method according to embodiments of the present invention will be described below.

The present invention is designed to solidify supercooled water in a wide range and thereby make a flight environment dry before the supercooled water touches an airframe of an aircraft. Supercooled water, which is unstable, has the property of turning into ice upon impact in order to gain stability. By taking advantage of this property, the present invention is intended to actively turn supercooled water into ice, remove the water ready to become ice from the flight environment, and thereby prevent icing on the aircraft. Incidentally, the aircraft addressed by the present invention are not limited to aircraft with fixed wings, and include aircraft with rotor blades.

### First Embodiment

First, a sound wave generator 1 according to a first embodiment of the present invention will be described.

By utilizing sound waves (pressure waves), the sound wave generator 1 actively turns supercooled water into ice, removes the water ready to become ice from the flight environment, and thereby prevents icing on the aircraft.

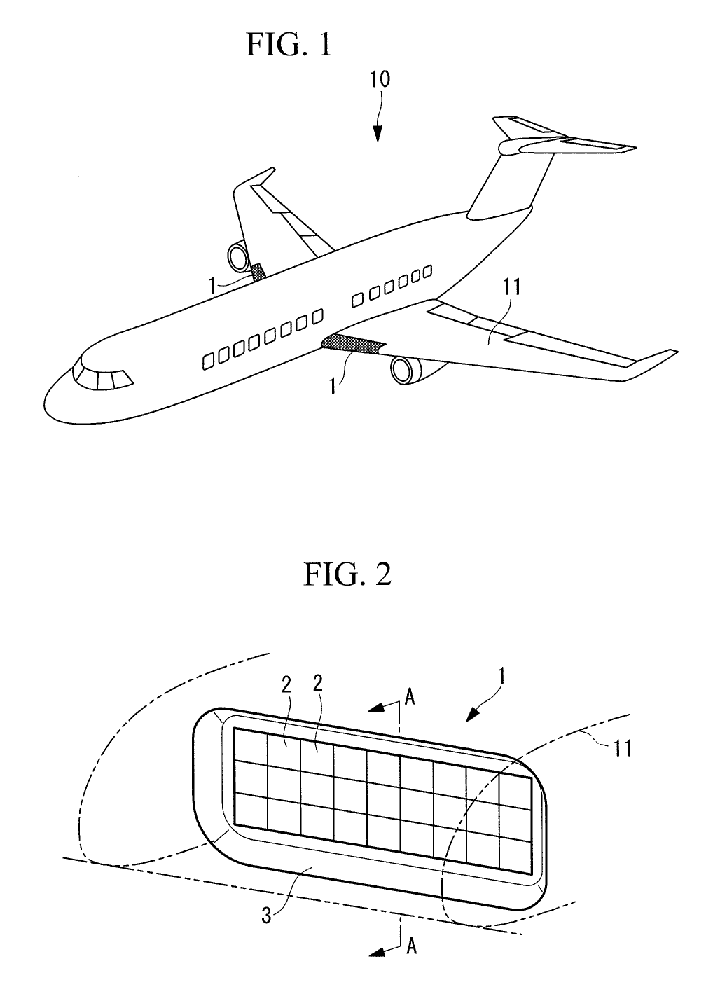

As shown in FIG. 1, the sound wave generators 1 are installed in forward part of an aircraft 10 and adapted to radiate sound waves forward of the airframe. The sound waves here are an example of pressure waves. FIG. 1 is a perspective view showing the aircraft 10 equipped with the sound wave generators 1 according to the present invention. Although FIG. 1 shows a case in which the sound wave generators 1 are installed on main wings 11, installation locations of the sound wave generator 1 according to the present invention are not limited to the main wings 11 as long as sound waves can be emitted forward of the aircraft 10.

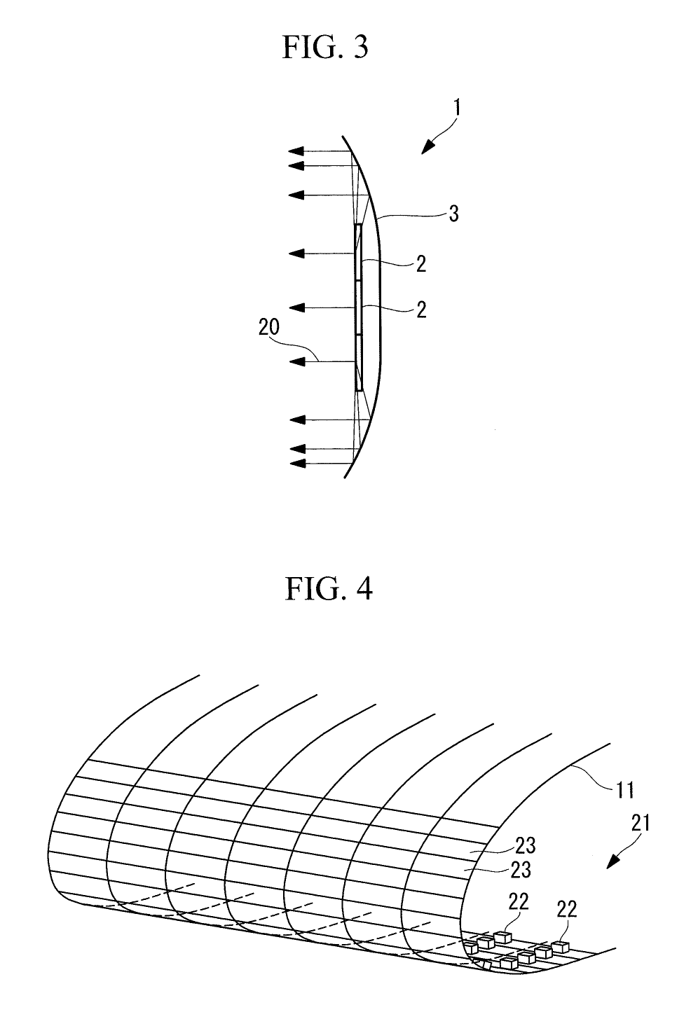

Normally, in the case of a point source, a sound wave spreads spherically, and thus is attenuated in inverse proportion to the square of the distance. Methods for remedying the attenuation of sound waves include a method of placing plural sound wave sources 2 as shown in FIGS. 2 and 3. FIG. 2 is a perspective view showing the sound wave generator 1 according to the present invention. FIG. 3 is a sectional view taken along line A-A in FIG. 2.

The sound wave generator 1 includes plural sound wave sources 2 arranged in a forward edge of the main wing 11 on the airframe so as to radiate sound waves in a planar manner. Furthermore, a parabolic reflector 3 is installed around or behind the plural sound wave sources 2 to prevent the sound waves from spreading.

In order to keep the airframe of the aircraft 10 in shape and maintain a flow of air, a cover needs to be placed on a front face of the plural sound wave sources 2. Incidentally, the sound waves are actually attenuated, but no particular mention will be made of this herein.

The sound wave generator 1 described above is made up of plural sound wave sources 2 arranged side by side, where each of the sound wave sources 2 can individually fire sound waves. By utilizing these features, if phases of the sound waves generated by the plural sound wave sources 2 are coadjusted, a direction in which the sound waves are radiated with high intensity can be moved up, down, left, and right. By utilizing the function to move the radiation direction of high-intensity sound waves, the sound waves are scanned across a plane through which the airframe of the aircraft 10 passes. This makes it possible to prevent icing on the airframe of the aircraft 10 using only the sound wave generators 1 placed in limited locations on the airframe of the aircraft 10.

By taking attenuation into consideration, the sound wave generator 1 is supposed to generate sound waves with a sound pressure of 3 [Pa] and a sound intensity of 100 [dB] at a predetermined location forward of the airframe. These levels allow an acceleration of 10 G to be imparted to supercooled water as described below. By imparting acceleration in this way, it is possible to turn the supercooled water into ice.

That is, regarding an impact value at which a cloud of airborne supercooled water droplets turns into ice, in view of the fact that supercooled water easily solidifies when poured into a glass or if one's hand slips during pouring, it can be said that an acceleration of 5 G will be enough to solidify supercooled water droplets when applied as an impact.

Although there is a difference between bottled state and airborne state, supercooled water in an airborne state will turn into ice when an acceleration of at least 10 G acts thereon. Based on this assumption, the sound pressure and sound intensity of sound waves used to turn supercooled water into ice were calculated.

If it is assumed that the sound pressure P of a sound wave changes sinusoidally, a force F acting on a water droplet with a diameter D is given by Eq. 1 below.

F=P·(πD²/4) (Eq. 1)

where P=P_{MAX} sin (ωt), in which P_{MAX} is maximum fluctuating pressure and ωt is a projected area of the water droplet.

If acceleration produced in the water droplet is a, the force F when the acceleration a acts is given by Eq. 2 below.

F=ρα(πD³/6) (Eq. 2)

where ρ is density and πD³/6 is the volume of the water droplet.

Assuming that the forces in Eq. 1 and Eq. 2 are to be balanced, a necessary sound pressure level is found.

P_{MAX} sin(ωt)≦P_{MAX}=(⅔)ρDα (Eq. 3)

If the density ρ of supercooled water is substituted with the value 0.9984×10³ [kg/m³] at a water temperature of 0 [° C.], the sound pressures [Pa] and sound intensities [dB] required for the equilibrium of forces when the diameters of suspended water droplets are 15, 20, 30, 40, and 50 [μm] are as shown in the table below. It can be seen that these sound pressures are available with a speaker or the like although the speaker or the like has to be on the large side.

TABLE 1

| | | Water particle size [μm] | | | | |
|---|---|---|---|---|---|---|
| Acceleration [G] | | 15 | 20 | 30 | 40 | 50 |
| 1 | Sound pressure [Pa] | 0.098 | 0.131 | 0.196 | 0.261 | 0.327 |
| | Sound intensity [dB] | 73.8 | 76.3 | 79.8 | 82.3 | 84.3 |
| 5 | Sound pressure [Pa] | 0.490 | 0.654 | 0.981 | 1.307 | 1.634 |
| | Sound intensity [dB] | 87.8 | 90.3 | 93.8 | 96.3 | 98.2 |
| 10 | Sound pressure [Pa] | 0.981 | 1.307 | 1.961 | 2.615 | 3.268 |
| | Sound intensity [dB] | 93.8 | 96.3 | 99.8 | 102.3 | 104.3 |

A relationship between the sound pressure [Pa] and sound intensity [dB] is given by Eq. 4 below.

L=20 log(P/P₀) (Eq. 4)

where L is the sound intensity (or sound pressure level) [dB], P is the sound pressure [Pa], and P₀ is the minimum sound pressure [Pa] audible to the human ear and is given by P₀=2×10⁻⁵ [Pa]=2×10⁻⁹ [N/cm²].

Furthermore, energy transported per unit area is given by Eq. 5 below.

[Energy transported per unit area]=[sound pressure]²/([air density]×[speed of sound]) (Eq. 5)

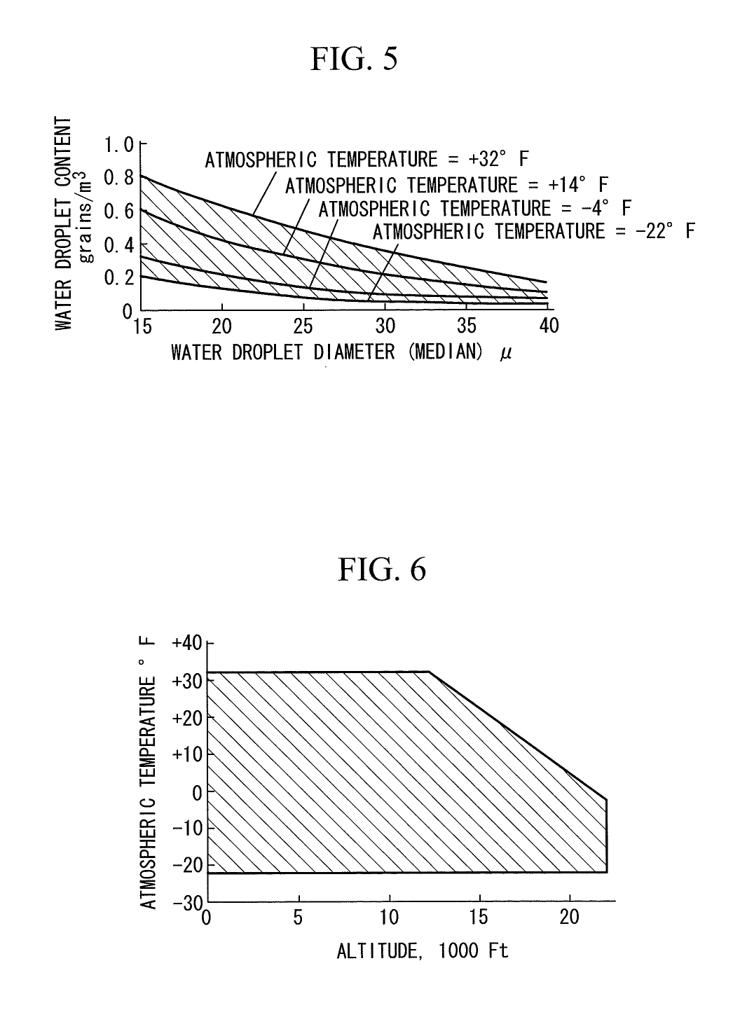

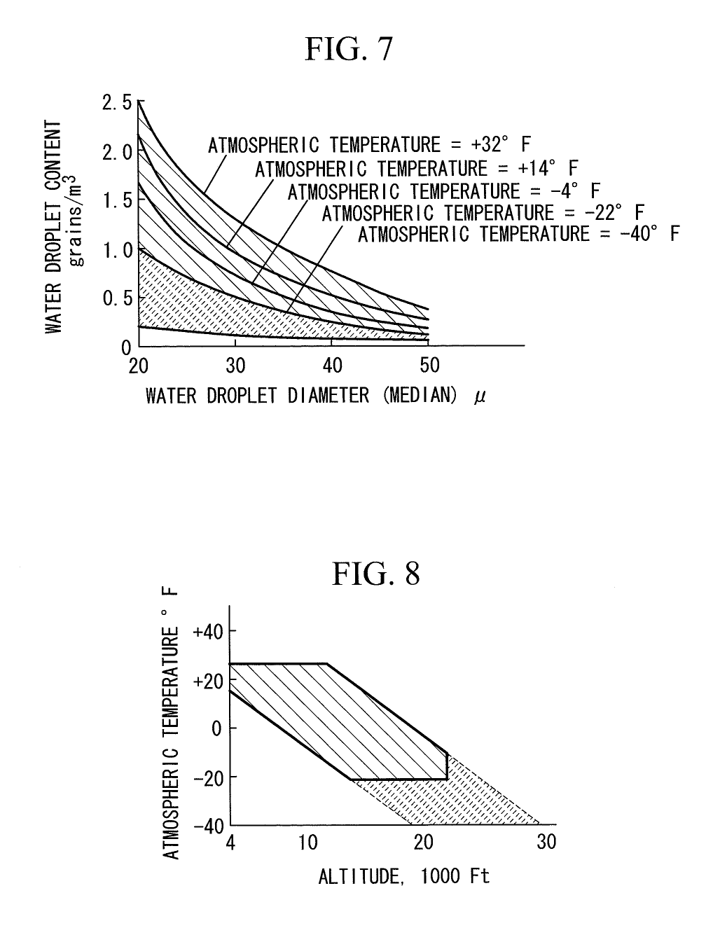

Thus, the sound wave energy transported per unit area [W/m²] needed to turn supercooled water into ice under icing conditions in FIGS. 5 to 8 was calculated. Shaded areas in FIGS. 5 to 8 are prescribed as icing conditions by FAR 25 (Part 25 of the Federal Aviation Regulations (FAR) of the Federal Aviation Administration (FAA)). The icing conditions shown in FIGS. 5 and 6 apply to situations in which clouds are spread over a wide area (20 miles). These conditions are marked as an icing area “continuous” in the tables below. The icing conditions shown in FIGS. 7 and 8 apply to situations in which although clouds spread over a small area (3 miles), clouds contain a large volume of water droplets. These conditions are marked as an icing area “intermittent” in the tables below. FIGS. 5 and 7 show graphs illustrating relationships between water droplet content [gr/m³] and water droplet diameter [μm] while FIGS. 6 and 8 are graphs showing relationships between atmospheric temperature [° F.] and pressure altitude [1000 Ft].

Although the icing conditions in FIGS. 5 to 8 are models, they show that an altitude at which icing occurs is normally 20 [kft] or below, and 30 [kft] or below at most. Therefore, since flight speed of the aircraft 10 at this altitude is considered to be lower than the speed of sound, it is believed that the present invention can control supercooled water so that supercooled water will not come into contact with the aircraft in the form of water droplets.

The sound pressure [Pa], sound intensity [dB], and energy transported per unit area [W/m²] required for supercooled water to gain an acceleration of 1 G were as show in the table below.

TABLE 2
Sound pressure, sound intensity, and energy needed to obtain an acceleration of 1 G

| | | | | | Atmos- | | Speed | | | | | | |
|---|---|---|---|---|---|---|---|---|---|---|---|---|---|
| | | | | | pheric | Air | of | | | | | | |
| Icing | Altitude | | Temperature | | pressure | density ρ | sound c | Water particle size [μm] | | | | | |
| Area | [kfeet] | [km] | [° F.] | [° C.] | [psia] | [kg/m³] | [m/sec] | 15 | 20 | 30 | 40 | 50 | |
| | | | | | | | | 0.098 | 0.131 | 0.196 | 0.261 | 0.327 | Re- |
| | | | | | | | | | | | | | quired |
| | | | | | | | | | | | | | sound |
| | | | | | | | | | | | | | pres- |
| | | | | | | | | | | | | | sure |
| | | | | | | | | | | | | | [PA] |
| | | | | | | | | 73.8 | 76.3 | 79.8 | 82.3 | 84.3 | Sound |
| | | | | | | | | | | | | | inten- |
| | | | | | | | | | | | | | sity |
| | | | | | | | | | | | | | [dB] |
| Con- | 0 | 0.000 | 32 | 0.000 | 14.696 | 1.293 | 331.450 | 0.002 | 0.004 | 0.009 | 0.015 | 0.024 | Energy |
| tin- | 0 | 0.000 | −22 | −30.000 | 14.696 | 1.453 | 312.729 | 0.002 | 0.004 | 0.008 | 0.014 | 0.023 | per |
| uous | 12 | 3.658 | 32 | 0.000 | 9.346 | 0.822 | 331.450 | 0.003 | 0.006 | 0.014 | 0.024 | 0.038 | unit |
| | 12 | 3.658 | −22 | −30.000 | 9.346 | 0.924 | 312.719 | 0.003 | 0.006 | 0.013 | 0.023 | 0.036 | area |
| | 22 | 6.706 | −4 | −20.000 | 6.206 | 0.589 | 319.085 | 0.005 | 0.009 | 0.020 | 0.035 | 0.055 | [W/ |
| | 22 | 6.706 | −22 | −30.000 | 6.206 | 0.614 | 317.719 | 0.005 | 0.009 | 0.019 | 0.034 | 0.054 | m²] |
| Inter- | 4 | 1.219 | 26 | −3.333 | 12.692 | 1.131 | 329.421 | 0.002 | 0.004 | 0.010 | 0.018 | 0.028 | |
| mit- | 4 | 1.219 | 14 | −10.000 | 12.692 | 1.159 | 325.326 | 0.002 | 0.004 | 0.010 | 0.017 | 0.027 | |
| tent | 12 | 3.658 | 26 | −3.333 | 9.346 | 0.832 | 325.421 | 0.003 | 0.006 | 0.013 | 0.024 | 0.037 | |
| | 12 | 3.658 | −15 | −26.111 | 9.346 | 0.909 | 315.210 | 0.003 | 0.006 | 0.013 | 0.023 | 0.036 | |
| | 14 | 4.267 | 19 | −7.222 | 8.633 | 0.780 | 327.039 | 0.004 | 0.006 | 0.014 | 0.026 | 0.040 | |
| | 14 | 4.267 | −22 | −30.000 | 8.633 | 0.854 | 312.719 | 0.003 | 0.006 | 0.014 | 0.025 | 0.038 | |
| | 19 | 5.791 | 1 | −17.222 | 7.041 | 0.661 | 320.831 | 0.004 | 0.008 | 0.017 | 0.031 | 0.048 | |
| | 19 | 5.791 | −40 | −40.000 | 7.041 | 0.726 | 306.221 | 0.004 | 0.007 | 0.017 | 0.030 | 0.046 | |
| | 22 | 6.706 | −10 | −23.333 | 6.206 | 0.597 | 316.977 | 0.005 | 0.009 | 0.020 | 0.035 | 0.054 | |
| | 22 | 6.706 | −22 | −30.000 | 6.206 | 0.614 | 312.719 | 0.005 | 0.009 | 0.019 | 0.034 | 0.054 | |
| | 22 | 6.706 | −40 | −40.000 | 6.206 | 0.640 | 306.221 | 0.005 | 0.008 | 0.019 | 0.034 | 0.052 | |
| | 29.4 | 8.961 | −40 | −40.000 | 4.4852 | 0.463 | 306.221 | 0.007 | 0.012 | 0.026 | 0.046 | 0.073 | |

The sound pressure [Pa], sound intensity [dB], and energy transported per unit area [W/m²] required for supercooled water to gain an acceleration of 5 G were as show in the table below.

TABLE 3
Sound pressure, sound intensity, and energy needed to obtain an acceleration of 5 G

| | | | | | Atmos- | | | | | | | | |
|---|---|---|---|---|---|---|---|---|---|---|---|---|---|
| | | | | | pheric | Air | Speed of | | | | | | |
| Icing | Altitude | | Temperature | | pressure | density ρ | sound c | Water particle size [μm] | | | | | |
| area | [kfeet] | [km] | [° F.] | [° C.] | [psia] | [kg/m³] | [m/sec] | 15 | 20 | 30 | 40 | 50 | |
| | | | | | | | | 0.490 | 0.654 | 0.981 | 1.307 | 1.634 | Required |
| | | | | | | | | | | | | | sound |
| | | | | | | | | | | | | | pressure |
| | | | | | | | | | | | | | [Pa] |
| | | | | | | | | 87.8 | 90.3 | 93.8 | 96.3 | 98.2 | Sound |
| | | | | | | | | | | | | | intensity |
| | | | | | | | | | | | | | [dB] |
| Contin- | 0 | 0.000 | 32 | 0.000 | 14.696 | 1.293 | 331.400 | 0.054 | 0.096 | 0.216 | 0.384 | 0.599 | Energy |
| uous | 0 | 0.000 | −22 | −30.000 | 14.696 | 1.453 | 312.719 | 0.051 | 0.000 | 0.203 | 0.362 | 0.565 | per unit |
| | 12 | 3.658 | 32 | 0.000 | 9.346 | 0.822 | 331.450 | 0.085 | 0.151 | 0.339 | 0.603 | 0.942 | area |
| | 12 | 3.658 | −22 | −30.000 | 9.346 | 0.924 | 312.719 | 0.080 | 0.142 | 0.320 | 0.569 | 0.889 | [W/m²] |
| | 22 | 6.706 | −4 | −20.000 | 6.206 | 0.589 | 319.085 | 0.123 | 0.219 | 0.492 | 0.874 | 1.366 | |
| | 22 | 6.706 | −22 | −30.000 | 6.206 | 0.614 | 312.719 | 0.120 | 0.214 | 0.482 | 0.857 | 1.338 | |
| Inter- | 4 | 1.219 | 26 | −3.333 | 12.692 | 1.131 | 329.421 | 0.062 | 0.110 | 0.248 | 0.441 | 0.690 | |
| mittent | 4 | 1.219 | 14 | −10.000 | 12.692 | 1.159 | 325.326 | 0.061 | 0.109 | 0.245 | 0.436 | 0.681 | |
| | 12 | 3.658 | 26 | −3.333 | 9.346 | 0.832 | 329.421 | 0.084 | 0.150 | 0.337 | 0.599 | 0.937 | |
| | 12 | 3.658 | −15 | −26.111 | 9.346 | 0.909 | 315.210 | 0.081 | 0.143 | 0.323 | 0.573 | 0.896 | |
| | 14 | 4.267 | 19 | −7.222 | 8.633 | 0.780 | 327.039 | 0.091 | 0.161 | 0.362 | 0.644 | 1.007 | |
| | 14 | 4.267 | −22 | −30.000 | 8.633 | 0.854 | 312.719 | 0.087 | 0.154 | 0.346 | 0.616 | 0.962 | |
| | 19 | 5.791 | 1 | −17.222 | 7.041 | 0.661 | 320.831 | 0.109 | 0.194 | 0.436 | 0.775 | 1.211 | |
| | 19 | 5.791 | −40 | −40.000 | 7.041 | 0.726 | 306.221 | 0.104 | 0.185 | 0.416 | 0.739 | 1.155 | |
| | 22 | 6.706 | −10 | −23.333 | 6.206 | 0.597 | 316.977 | 0.122 | 0.217 | 0.488 | 0.868 | 1.357 | |
| | 22 | 6.706 | −22 | −30.000 | 6.206 | 0.614 | 312.719 | 0.120 | 0.214 | 0.482 | 0.857 | 1.338 | |
| | 22 | 6.706 | −40 | −40.000 | 6.206 | 0.640 | 306.221 | 0.118 | 0.210 | 0.472 | 0.839 | 1.311 | |
| | 29.4 | 8.961 | −40 | −40.000 | 4.4852 | 0.463 | 306.221 | 0.163 | 0.290 | 0.653 | 1.161 | 1.813 | |

The sound pressure [Pa], sound intensity [dB], and energy transported per unit area [W/m²] required for supercooled water to gain an acceleration of 10 G were as show in the table below.

TABLE 4
Sound pressure, sound intensity and energy needed to obtain an accleration of 10 G

| | | | | | Atmos- | | Speed | | | | | | |
|---|---|---|---|---|---|---|---|---|---|---|---|---|---|
| | | | | | pheric | Air | of | | | | | | |
| Icing | Altitude | | Temperature | | pressure | density ρ | sound c | Water particle size [μm] | | | | | |
| area | [kfeet] | [km] | [° F.] | [° C.] | [psia] | [kg/m³] | [m/sec] | 15 | 20 | 30 | 40 | 50 | |
| | | | | | | | | 0.981 | 1.307 | 1.961 | 2.615 | 3.268 | Required |
| | | | | | | | | | | | | | sound |
| | | | | | | | | | | | | | pressure |
| | | | | | | | | | | | | | [Pa] |
| | | | | | | | | 93.8 | 96.3 | 99.8 | 102.3 | 104.3 | Sound |
| | | | | | | | | | | | | | intensity |
| | | | | | | | | | | | | | [dB] |
| Contin- | 0 | 0.000 | 32 | 0.000 | 14.696 | 1.293 | 331.400 | 0.216 | 0.384 | 0.863 | 1.534 | 2.397 | Energy |
| uous | 0 | 0.000 | −22 | −30.000 | 14.696 | 1.453 | 312.719 | 0.203 | 0.362 | 0.814 | 1.447 | 2.261 | per unit |
| | 12 | 3.658 | 32 | 0.000 | 9.346 | 0.822 | 331.450 | 0.339 | 0.603 | 1.357 | 2.412 | 3.769 | area |
| | 12 | 3.658 | −22 | −30.000 | 9.346 | 0.924 | 312.719 | 0.320 | 0.569 | 1.280 | 2.275 | 3.555 | [W/m²] |
| | 22 | 6.706 | −4 | −20.000 | 6.206 | 0.589 | 319.085 | 0.492 | 0.874 | 1.967 | 3.497 | 5.464 | |
| | 22 | 6.706 | −22 | −30.000 | 6.206 | 0.614 | 312.719 | 0.482 | 0.857 | 1.927 | 3.427 | 5.354 | |
| Inter- | 4 | 1.219 | 26 | −3.333 | 12.692 | 1.131 | 329.421 | 0.248 | 0.441 | 0.993 | 1.765 | 2.759 | |
| mittent | 4 | 1.219 | 14 | −10.000 | 12.692 | 1.159 | 325.326 | 0.245 | 0.436 | 0.981 | 1.743 | 2.724 | |
| | 12 | 3.658 | 26 | −3.333 | 9.346 | 0.832 | 329.421 | 0.337 | 0.599 | 1.349 | 2.397 | 3.746 | |
| | 12 | 3.658 | −15 | −26.111 | 9.346 | 0.909 | 315.210 | 0.323 | 0.573 | 1.290 | 2.294 | 3.584 | |
| | 14 | 4.267 | 19 | −7.222 | 8.633 | 0.780 | 327.039 | 0.362 | 0.644 | 1.449 | 2.577 | 4.026 | |
| | 14 | 4.267 | −22 | −30.000 | 8.633 | 0.854 | 312.719 | 0.346 | 0.616 | 1.386 | 2.463 | 3.849 | |
| | 19 | 5.791 | 1 | −17.222 | 7.041 | 0.661 | 320.831 | 0.436 | 0.775 | 1.743 | 3.099 | 4.842 | |
| | 19 | 5.791 | −40 | −40.000 | 7.041 | 0.726 | 306.221 | 0.416 | 0.739 | 1.663 | 2.957 | 4.620 | |
| | 22 | 6.706 | −10 | −23.333 | 6.206 | 0.597 | 316.977 | 0.488 | 0.868 | 1.954 | 3.473 | 5.427 | |
| | 22 | 6.706 | −22 | −30.000 | 6.206 | 0.614 | 312.719 | 0.482 | 0.857 | 1.927 | 3.427 | 5.354 | |
| | 22 | 6.706 | −40 | −40.000 | 6.206 | 0.640 | 306.221 | 0.472 | 0.839 | 1.887 | 3.355 | 5.242 | |
| | 29.4 | 8.961 | −40 | −40.000 | 4.4852 | 0.463 | 306.221 | 0.653 | 1.161 | 2.611 | 4.642 | 7.253 | |

As can be seen from the table above, the sound pressure, sound intensity, and energy transported per unit area required for supercooled water to gain an acceleration of 10 G are approximately 0.9 to 3.3 [Pa], approximately 93 to 105 [dB], and approximately 0.2 to 7.5 [W/m²], respectively. Therefore, by taking attenuation into consideration, it is advisable that the sound wave generator 1 generate pressure waves with a sound pressure of approximately 0.9 to 3.3 [Pa] in an area forward of the targeted airframe. Incidentally, the sound pressure, sound intensity, and energy transported per unit area required for supercooled water to gain an acceleration of 5 G are approximately 0.4 to 1.7 [Pa], approximately 87 to 99 [dB], and approximately 0.05 to 1.9 [W/m²], respectively.

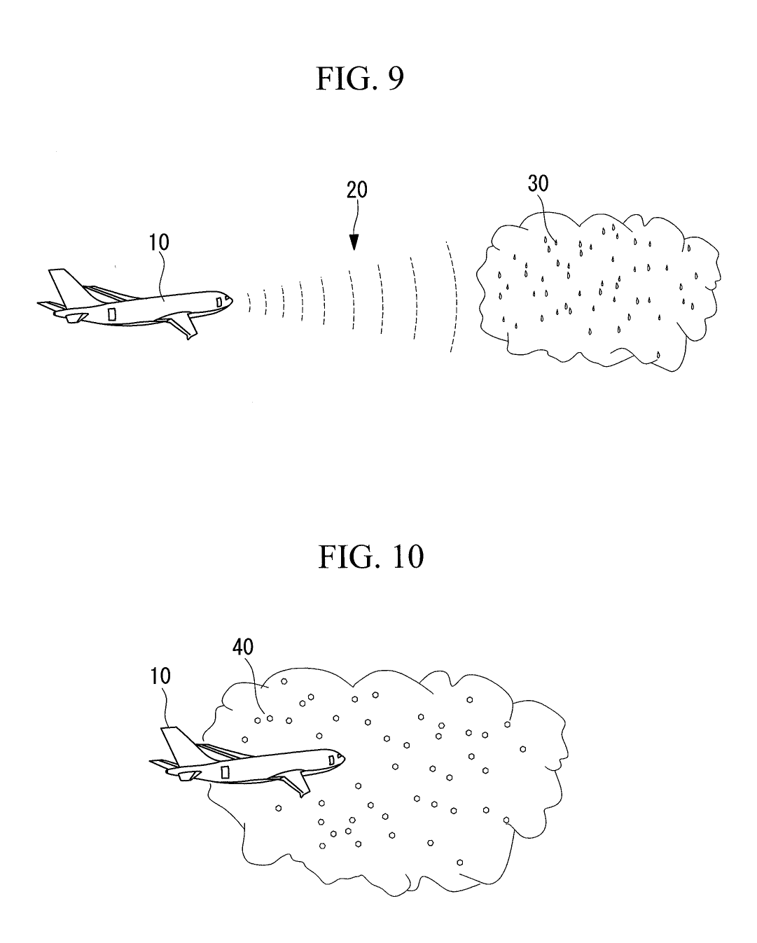

Thus, when the sound wave generator 1 is placed in forward part of the aircraft 10, the sound wave generator 1 fires sound waves 20 toward the flight environment ahead, specifically toward supercooled water 30, as shown in FIG. 9. The sound wave generator 1 according to the present invention can change supercooled water into ice in a wide area to which the sound waves propagate. Therefore, the supercooled water 30 changes into ice 40, and consequently disappears from the flight environment. Consequently, as shown in FIG. 10, even if the aircraft flies into the environment in which a change into ice 40 has already taken place, no icing will occur on the aircraft 10. FIG. 9 is an explanatory diagram illustrating the aircraft 10 in flight and the supercooled water 30 in the flight environment while FIG. 10 is an explanatory diagram illustrating the aircraft 10 in flight and the ice 40 in the flight environment.

Next, a sound wave generator 21, which is a modification of the sound wave generator 1 according to the present invention, will be described with reference to FIG. 4. The sound wave generator 21 in FIG. 4 is an example of an anti-icing system, in which plural sound wave sources 22 are installed inside a skin 23 of a main wing 11 of the aircraft 10. By utilizing the skin 23 of the airframe, the sound wave generator 21 generates sound waves directly from the skin 23. The sound wave generators 21 are installed at the same locations as the sound wave generators 1, i.e., in the forward part of the aircraft 10 shown in FIG. 1 and adapted to radiate sound waves forward of the airframe. The sound waves here are an example of pressure waves.

According to the present modification, the sound wave generator 21 has a plurality of elements to radiate sound waves. Then, through phase control of each element, sound waves can be radiated such that sound wave pressure in a specific direction will be stronger.

When the sound wave generator 1 or 21 according to the present invention is installed on an aircraft, such as a helicopter, which has rotor blades, the sound wave generator 1 or 21 is installed, for example, on a forward part of a fuselage or on landing gear.

### Second Embodiment

Next, an anti-icing method according to a second embodiment of the present invention will be described.

Although in the above embodiment, an example in which the aircraft 10 equipped with an anti-icing system radiates waves forward has been described, the present invention is not limited to this example. For example, apart from the aircraft 10 desired to be protected from icing, facilities equipped with an anti-icing system may be provided on the ground. However, it is not realistic to install, on the ground, the same anti-icing system as the one mounted on the aircraft 10 described above because of too large an area to be covered.

Thus, a rocket is launched from emergency ground facilities, and when the rocket reaches the altitude of clouds containing supercooled water, sound waves (pressure waves) are radiated by explosion of gunpowder. Consequently, water droplets existing as supercooled water are changed into ice in a wide range before coming into contact with the aircraft, temporarily correcting the icing environment above the airport and its surroundings. This prevents icing on the aircraft, and thereby supports safe landing.

However, this system is not available for use when there is an aircraft nearby because depending on the amount of gunpowder, pressure waves could be so strong as to damage the aircraft. Thus, tentative calculations were made to see whether the energy needed to turn supercooled water into ice can be generated by sound pressure produced by explosion of a reasonable amount of gunpowder.

A Wikipedia entry on “gunpowder” contains description of cast trinitrotoluene (TNT), and the following values are indicated. (According to a value cited in another document, TNT explosives develop approximately 4.2×10⁶ [3] per kilogram, but the energy cited below is smaller and on the safe side, and thus the values cited below are used in the following discussion.

Radius: 10 [cm]

Weight: 6.49 [kg]

Heat of explosion: Approximately 1.17×10⁷ [J]

Reaction time: 14.7 nsec.

Rate of energy production: 1.16×10¹² [J/sec](=[W])

The weight of gunpowder needed to produce 2 [W/m²] when clouds spread over 20 [miles] is calculated below.

20 [miles]=32,186.2 [m]

Assuming that pressure waves spread spherically as a result of a gunpowder explosion, required energy per time is

4π×32,186.2²×2=2.604×10¹⁰ [W]

If it is assumed that efficiency is only 10 [%], the required amount of gunpowder is

6.49×(2.604×10¹⁰)/(1.16×10¹²)/0.1=1.457[kg]

At this time, the radius of gunpowder is

10×{1.457/6.49}^{1/3}=6.1[cm]

Thus, it can be seen that anti-icing by means of gunpowder explosion is feasible in terms of magnitude.

However, another Wikipedia entry “blast” contains description of pressure at which damage occurs to a structure, where the pressure reaches approximately 1,000 times or more the pressure needed to change supercooled water into ice. When distance is calculated based on this figure, if the pressure produced is just enough to change supercooled water into ice in a range of 20 [miles], the range in which damage occurs to a structure is approximately 1 [km]. If the pressure produced is equal to or higher than the pressure needed to change supercooled water into ice at a distance of 20 [miles], the range in which pressure is high enough to cause damage to a structure becomes larger.

Thus, when the anti-icing method using gunpowder is adopted, desirably the method is performed by carrying the gunpowder to an altitude high enough to ensure that the generated pressure waves are harmless in terms of intensity. Also, in the above tentative calculations, to consider the amount of gunpowder by staying on the safe side, the energy efficiency of gunpowder which represents pressure is estimated to be 10 [%], but the amount of gunpowder needs to be checked by testing and decreased to avoid the danger of actual blasts.

Thus, the present invention is entirely different from conventional methods and is designed to cause supercooled water itself, which is responsible for icing, to disappear from the surroundings. The anti-icing system and anti-icing method according to the present invention is relatively inexpensive and lightweight and involves lower energy than other methods. Also, the sound wave generator 1 according to a first embodiment has the advantage that there is no need to be located at the desired de-icing site. Incidentally, the aircraft 10 equipped with the sound wave generator 1 can fly ahead of an aircraft not equipped with the anti-icing system to support safe landing of the latter.

### REFERENCE SIGNS LIST

1, 21 Sound wave generator
2, 22 Sound wave source
10 Aircraft
11 Main wing
23 Skin

1. An anti-icing system adapted to generate a pressure wave by aiming at supercooled airborne water droplets existing in a traveling direction of an aircraft and thereby change the water droplets into ice by means of the pressure wave.

2. An anti-icing system adapted to generate a pressure wave in a range of 0.9 to 3.3 [Pa] at a predetermined location forward of an airframe by aiming at supercooled airborne water droplets existing in a traveling direction of an aircraft.

3. A wing equipped with the anti-icing system according to claim 1.

4. An aircraft equipped with the anti-icing system according to claim 1.

5. An anti-icing method for generating a pressure wave by aiming at supercooled airborne water droplets existing in a traveling direction of an aircraft and thereby changing the water droplets into ice by means of the pressure wave.

6. The anti-icing method according to claim 5, wherein the pressure wave generation is achieved by explosion of gunpowder.

7. A wing equipped with the anti-icing system according to claim 2.

8. An aircraft equipped with the anti-icing system according to claim 2.
